(19) United States
(12) Patent Application Publication
(10) Pub. No.: US 2026/0062130 A1
(43) Pub. Date: Mar. 5, 2026

(54) AIRCRAFT DOOR ARCHITECTURE COMPRISING AN EMERGENCY ENERGY SOURCE

(71) Applicant: LATECOERE, Toulouse (FR)

(72) Inventor: Sebastien DEVILLEZ, Saint Jean (FR)

(73) Assignee: LATECOERE, Toulouse (FR)

(21) Appl. No.: 19/383,854

(22) Filed: Nov. 10, 2025

Related U.S. Application Data
(63) Continuation-in-part of application No. 18/255,884, now Pat. No. 12,491,980.

(30) Foreign Application Priority Data
Dec. 5, 2020 (FR) FR2012739

(51) Int. Cl. B64D 25/14; B64C 1/14; H02J 9/06

(52) U.S. Cl. CPC B64D 25/14; B64C 1/1407; H02J 9/061; B64D 2221/00

(57) ABSTRACT

An aircraft door architecture having: a door (1); an ejector (3); an inflatable evacuation device (4); a supercapacitor as an emergency energy source (6) that is connected to the retaining bar actuator (5), a control unit (9) having the two following operating states: a nominal operating state in which the inflatable evacuation device (4) is kept in its retracted position and the emergency energy source is deactivated; an emergency operating state in which the emergency energy source (6) activates the actuation device of the ejector (3) in an emergency opening mode of the door (1), and activates the inflation device of the inflatable evacuation device (4) in an emergency inflation mode.

### CROSS REFERENCE TO RELATED APPLICATION

This application is a continuation-in-part of U.S. application Ser. No. 18/255,884 filed Jun. 5, 2023, entitled, AIRCRAFT DOOR ARCHITECTURE COMPRISING AN EMERGENCY ENERGY SOURCE, allowed, which is a national stage entry of PCT/EP2021/083153, filed Nov. 26, 2021, under the International Convention and claiming priority over French Patent Application No. FR2012739, filed Dec. 5, 2020. The contents of all of them are incorporated herein by reference.

### TECHNICAL FIELD

The invention concerns the field of aeronautics and more particularly concerns the safety units in an aircraft door architecture.

### PRIOR ART

Numerous aircraft are equipped with doors mounted in an opening in the fuselage to give access to the interior of the aircraft. The doors are adapted to occupy: a closed position that enables safe flight of the aircraft and pressurization of the interior of the aircraft; and an open position that enables access to the cabin or to the hold.

These aircraft doors are generally part of an architecture that comprises, in addition to the door, maneuvering mechanisms, as well as safety equipment.

Aircraft door architectures having to serve as emergency exits generally comprise: at least one ejector adapted to drive emergency opening of the door; and an inflatable actuation device, such as a slide enabling evacuation of the aircraft in the event of an accident once deployed.

Inflatable evacuation devices are generally associated with emergency inflation means that must enable very rapid inflation of the device for emergency evacuation of the aircraft. The commonest inflation means consist of a cylinder of pressurized inert gas, such as nitrogen.

The actuation means of the ejectors also generally consist of a cylinder of pressurized gas enabling activation of the ejector in an emergency door opening mode that enables very rapid opening of the door requiring minimal effort by the user.

Other means for inflating the inflatable evacuation device are known. For example, the patent application WO2016/061446 describes an inflatable evacuation device that is inflated by a compressor powered by a battery.

Other means for actuating an ejector are also known. For example, the patent application FR2975967 describes an ejector with mechanical actuation means. Also, some airliners are equipped with electric actuators on their doors.

### SUMMARY OF THE INVENTION

An aircraft door architecture including:
a door adapted to be mounted in an opening in a fuselage of an aircraft and adapted to occupy an open position and a closed position;
an ejector adapted to drive emergency opening of the door;
an inflatable evacuation device adapted to occupy a retracted storage position and a deployed evacuation position;
a retaining bar actuator that can be activated between: an arming position in which the inflatable evacuation device is retained; and a disarming position in which the inflatable evacuation device is released;
a supercapacitor as an emergency energy source connected to the retaining bar actuator, the emergency energy source being adapted to activate an actuating device for actuating the ejector, an inflating device for inflating the inflatable evacuation device, and the retaining bar actuator;
a control unit having the following two operating states: a nominal operating state in which the inflatable evacuation device is retained in the retracted position and the emergency energy source is deactivated; and an emergency operating state in which the emergency energy source activates the actuating device in an emergency mode of opening the door and activates the inflating device in an emergency inflation mode;
wherein the emergency energy source is an electric secondary cell;
the ejector includes an electric actuation device; the inflatable evacuation device includes an electric inflation device;
wherein the emergency energy source includes a supercapacitor; and
wherein the supercapacitor powers the retaining bar actuator and powers the ejector and the inflating device.

The supercapacitor is always charged and acts directly on the mechanical opening means, ensuring faster response compared to thermal batteries. In addition, the supercapacitor is more compact (and potentially lighter) than thermal batteries and does not control the slide inflation as the thermal batteries.

Here an aircraft door architecture is defined as a combination formed by an aircraft door and by various items of comfort and safety equipment that are associated with that door, whether they are mounted directly on the door or in the environment of the door. An aircraft door architecture comprises at least an aircraft door, an ejector, and an inflatable evacuation device. This architecture therefore includes various elements intended to interact. For example, the ejector and the inflatable evacuation device can be mounted on the door. The various elements of the door architecture are interconnected in a physical and functional manner.
kind of aircraft door architecture benefits from the use of a single emergency energy source, supercapacitor, powering the retaining bar actuator.

The invention, in particular, enables the use of a single energy source for all the emergency systems of the door so that the weight, acquisition cost and maintenance cost are reduced. This emergency source is segregated from the rest of the aircraft onboard energy management system so that no untimely opening of the door is to be feared.

The components powered by the emergency energy source, when it is electric, can moreover be more easily regulated: an ejector provided with electric actuation means can be more easily regulated in terms of opening speed during its travel in emergency opening mode by electronic control means.

In accordance with one embodiment, the ejector includes connectors for electrical connection to an onboard electrical network of an aircraft, the electric actuation means of the ejector being also adapted to be activated by an aircraft onboard electrical network.

In accordance with this embodiment, the activation means of the ejector, as well as any other electric actuator adapted to be powered by the emergency energy source, can moreover be used in the nominal operating state. These actuators are then powered by the aircraft onboard electrical network. These actuators then serve two functions: a function in the nominal operating state that aims to assist users during normal functioning of the door, for example by automating the opening or the closing of the door, or replacing activation of mechanical levers by electronic control; and a safety function in the emergency operating state, in particular, emergency opening of the door powered by the emergency energy source.

The aircraft door architecture according to the invention may have the following features, separately or in combination:
it further includes a retaining bar actuator that is activatable between: an arming position in which the inflatable evacuation device is retained; and a disarming position in which the inflatable evacuation device is released; the emergency energy source being also connected to the retaining bar actuator, the emergency energy source being adapted to activate the retaining bar actuator;
the control unit includes a control interface for a user; this control interface being adapted to drive the retaining bar actuator to its arming position or its disarming position when the control unit is in its nominal operating state;
the control unit further includes an opening from the exterior operating state in which the control unit drives the retaining bar actuator to its disarming position in the event of opening of the door from the exterior;
in the opening from the exterior operating mode the control unit activates the means for actuating the ejector in a nominal mode of opening the door;
in its nominal operating state, the control unit is adapted to control the ejector in accordance with a mode for assisting opening/closing of the door;
the control interface for a user is adapted also to control the ejector in the mode for assisting opening/closing of the door;
the emergency energy source is activated by a mechanical trigger connected to a mechanism for opening/closing the door;
the door comprises an arming/disarming handle and in that the mechanism for opening/closing the door comprises an opening handle that is mechanically connected to the mechanical trigger by means of a coupling means actuated by the arming/disarming handle;
In one embodiment, the emergency energy source includes a thermal battery, in another embodiment, the emergency energy source includes a supercapacitor The thermal battery will require replacement;
When the emergency energy source is a thermal battery, a first thermal battery adapted to power electrically the retaining bar actuator and to activate a second thermal battery of greater capacity than the first thermal battery, the second thermal battery being adapted to power electrically the ejector and the means for inflating the inflatable evacuation device;
When the emergency source is a supercapacitor, the supercapacitor is always charged and acts directly on the mechanical opening means, ensuring faster response compared to thermal batteries. In addition, the supercapacitor is more compact (and potentially lighter) than thermal batteries and does not control the slide inflation device as the thermal batteries.
the door architecture includes an isolation box having a mode enabling electrical connection of the ejector and a mode for breaking that electrical connection;
the isolation box is activated in breaking mode upon activation of the emergency energy source;
the retaining bar actuator includes connectors for electrical connection to an onboard electrical network of an aircraft, the retaining bar actuator being also adapted to be activated by an aircraft onboard electrical network.

The opening handle that is referred to here as forming part of the opening/closing mechanism of the door and that is mechanically connected to the mechanical trigger by a coupling means may be an interior opening handle or an exterior opening handle, aircraft generally including these two types of opening handle.

### BRIEF DESCRIPTION OF THE FIGURES

Other features and advantages of the invention will emerge from the following non-limiting description with reference to the appended drawings in which:

FIG. 1 represents schematically an aircraft door architecture according to an embodiment of the invention using a thermal battery;

FIG. 2 is a diagram illustrating the operation of the aircraft door architecture;

FIG. 3 is a view similar to FIG. 1 for a second embodiment of the invention; and

FIG. 4 shows schematically an aircraft door architecture according to another embodiment of the invention using a supercapacitor.

### DETAILED DESCRIPTION OF THE INVENTION

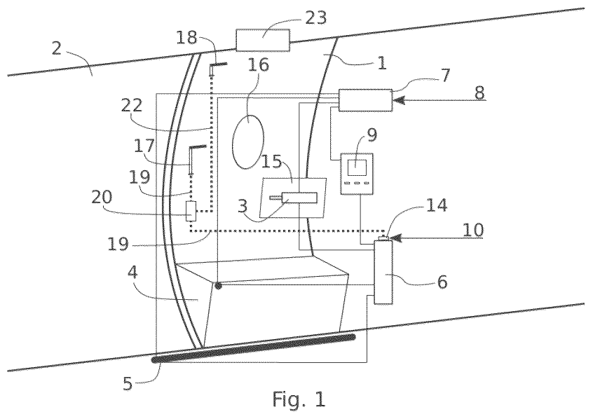

FIG. 1 represents schematically an aircraft portion in which is installed an aircraft door architecture according to the invention.

This architecture comprises:
a door 1 mounted in an opening in the fuselage 2 of the aircraft;
an ejector 3 adapted to drive emergency opening of the door 1;
an inflatable evacuation device 4 that hereby includes an inflatable slide mounted on the door 1 in a retracted storage position;
a retaining bar associated with an actuator 5 enabling attachment of the inflatable evacuation device 4 to the aircraft.

The door 1 is articulated by an arm 15, so as to be able to occupy an open position and a closed position. A safety porthole 16 enables the external conditions to be seen before opening the door 1.

This aircraft architecture includes an emergency electric network consisting of an emergency energy source 6 that is connected to the ejector 3, to the inflatable evacuation device 4 and to the retaining bar actuator 5. The emergency energy source 6 may optionally be connected to any other safety equipment that has to be activated during an emergency maneuver.

The door 1 further comprises an interior opening handle 17 driving a classic mechanism (not represented) for opening/closing the door, this mechanism enabling locking and unlocking of the door in its frame. This opening/closing mechanism is also controlled by an exterior handle (not visible in FIG. 1) that is accessible from the exterior of the aircraft.

The door 1 further comprises an arming/disarming handle 18 adapted to occupy two positions: an arming position corresponding to the deployment of the inflatable evacuation device 4 once the door 1 has been locked; and a disarming position corresponding to deactivation of the inflatable evacuation device 4. The inflatable evacuation device 4 may be armed or disarmed mechanically or electrically.

In addition to their classic function, the interior opening handle 17, the exterior opening handle and the arming/disarming handle 18 serve a function relating to the invention and in this regard are associated with mechanical connection means 19, 22. The interior opening handle 17 and the exterior opening handle are mechanically connected to a mechanical trigger 14 of the emergency energy supply 6 by a coupling means 20 that is actuated by a mechanical connection means 22 relative to the arming/disarming handle 18.

The aircraft door architecture further comprises connectors electrically connected to the onboard electric network of the aircraft. The door architecture therefore comprises an isolation box 7 to which the onboard electric network of the aircraft is connected, for example a 28 V DC network (schematically represented by the arrow 8). The isolation box 7 distributes electrical energy from the onboard network to the ejector 3, as well as to the retaining bar actuator 5. The isolation box 7 moreover functions in two modes:
a mode enabling electrical connection of the ejector 3 and of the retaining bar actuator 5 to the onboard network;
a mode of breaking that electrical connection.

The aircraft door architecture further comprises a control unit 9 connected to the emergency energy source 6, as well as to the isolation box 7. The control unit 9 has the following two operating states:
a nominal operating state in which the inflatable evacuation device 4 is retained in its retracted position and the emergency energy source is deactivated, and
an emergency operating state in which the emergency energy source 6 activates the actuation means of the ejector 3 in a mode for emergency opening of the door 1 and activates the inflation means of the inflatable evacuation device 4 in an emergency inflation mode.

The nominal operating state corresponds to normal use of the door 1, which can therefore be closed and locked, as well as unlocked and opened, without activating the inflatable evacuation device 4. The emergency operating state corresponds to a situation in which the door 1 is opened during an emergency maneuver by means of the interior handle 17.

The control unit 9 is moreover connected to a set of sensors supplying information as to the state of the door at any time, which is to say on the physical position of the door 1, as well as on the position of all its control elements. This set of sensors is schematically represented in FIG. 1 by a box 23.

### Embodiment Using the Thermal Battery as Emergency Energy Source

The emergency energy source 6 may consist of any energy source adapted to actuate the ejector, as well as to inflate the inflatable evacuation device 4. It may, for example, be a single cylinder of gas under pressure or preferably a source of electrical energy. In accordance with an embodiment of the present invention the emergency energy source 6 includes a thermal battery obtained by stacking cells, each of which includes a layer forming the anode, a solid electrolyte layer, a layer forming the cathode and a heat source layer.

Here the thermal battery has the advantage that it can be stored for a very long time without deterioration of its energy potential. Moreover, the thermal battery is adapted to supply a large quantity of energy (here reflected in a high current) in very little time for triggering the safety elements, in particular the ejector and the inflatable evacuation device. The thermal battery requires for its activation a small quantity of energy that can be supplied by the mechanical work of a maneuver actuated by a user. In this regard, the thermal battery is activated by a mechanical trigger 14 connected to a door opening mechanism. To be more precise, when the arming/disarming handle is in the armed position, the movement of an opening handle may be exploited to activate the thermal battery. Activation of the thermal battery here constituting the emergency energy source 6 is schematically represented by the arrow 10 in FIG. 1. This activation is therefore affected by the mechanical trigger 14, which is itself driven by the mechanical connection means 19 connected to the handle 17 (as well as to the exterior opening handle that cannot be seen in the figure). The coupling means 20 is a mechanical device (latch or other device) that is driven by the arming/disarming handle 18 and enables:
mechanical coupling of the (interior and exterior) opening handles to the mechanical trigger 14 of the emergency energy source 6 so that actuation of this handle 17 activates the emergency energy source 6 when the arming/disarming handle 18 is in its arming position; and
decoupling the opening handle 17 from the mechanical trigger 14 when the arming/disarming handle 18 is in its disarming position, so that this handle 17 controls only the opening mechanism of the door, in the classic manner, without acting on the mechanical trigger 14.

The coupling means 20 is driven by the arming/disarming handle 18 by means of the mechanical connection means 22. The mechanical connection means 22 may, for example, be a link or any other mechanical transmission device.

The ejector 3, in this example, includes electric actuation means. In the FIG. 1 schematic the ejector 3 is, for example, an electric cylinder or a linear motor. It may equally be an electric motor, possibly with a reducer, driving directly in rotation a shaft of the door mechanism driving opening of the door 1. The ejector 3 additionally carries its control electronics enabling: in a nominal operating state, assisting or motorizing opening and closing of the door 1, using energy from the onboard electric network 8; and an emergency mode for opening the door 1 very rapidly, thanks to energy from the emergency energy source 6.

Here the inflatable evacuation device 4 includes an inflatable slide that is classic in the aeronautical field, as well as means for inflating this slide. In the present example, the inflation means include a 4000 W electric motor directly driving a radial pump at 14,000 revolutions/min enabling rapid inflation of the slide when this motor is powered by the emergency energy source 6.

Here the retaining bar actuator 5 includes an electric actuator (cylinder or rotary motor) enabling arming or disarming of the inflatable evacuation device 4, that is to say, locking retaining hooks onto the retaining bar or to the contrary releasing them. When the actuator 5 disarms the device 4, the control unit 9 is in a nominal operating state. The door 1 can be opened or closed, carrying as it moves the inflatable evacuation device 4 without triggering it. When the actuator 5 arms the inflatable evacuation device 4, the retaining bar is retained against the floor of the aircraft and the inflatable evacuation device 4 is ready to be triggered. In the event of a maneuver opening the door in this configuration, the thermal battery constituting the emergency energy source 6 is activated and the control unit 9 then goes to an emergency operating state. The control unit, then in particular, brings about inflation of the inflatable evacuation device 4, which remains attached to the floor of the aircraft.

Here the retaining bar actuator 5 is electrically driven according to the position of the arming/disarming handle 18. Alternatively, the actuator 5 is driven directly by the physical movement of the arming/disarming handle 18.

The isolation box 7 includes circuit-breaker elements including, for example, of relays or power transistors and enabling cutting of the electrical connection between the onboard electric network 8 and the elements that are powered by that network in the nominal operating state (the ejector 3 and the retaining bar actuator 5 in this example). The control unit 9 is adapted to control the isolation box 7 to connect or to disconnect the supply of energy from the onboard electric network 8.

The control unit 9 is moreover connected to the emergency energy source 6. The control unit 9 is therefore able to tell the (activated or not activated) state of the emergency energy source 6 and can moreover obtain its own supply of electrical energy from either the onboard network 8 (resulting from its connection to the isolation box 7) or the emergency energy source 6.

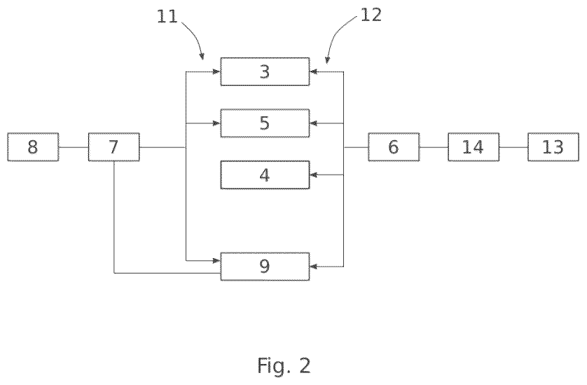

FIG. 2 is a diagram illustrating how the aircraft door architecture that has been described functions.

The ejector 3, the inflatable evacuation device 4 and the retaining bar actuator 5 are represented in the form of rectangles at the center of the figure. To the left of these rectangles, FIG. 2 depicts the onboard electrical network of the aircraft, here with the isolation box 7 connected to the electrical network 8 of the aircraft. The powering of the ejector 3 and of the actuator 5 by the onboard electrical network via the isolation box 7 is schematically represented by the arrows 11.

FIG. 2 moreover depicts, on the right in the diagram, the elements enabling powering of the actuators by the emergency energy source 6. This is schematically represented by the arrows 12.

This schematic view in FIG. 2 moreover depicts the control unit 9 that is also connected to the onboard electrical network 8 and to the emergency energy source 6.

When the aircraft door is in its normal operating mode, the control unit 9 is electrically powered by the onboard electrical network 8 and is in its nominal operating state. The door can be opened to enable access to the cabin of the aircraft and can be closed to enable flight of the aircraft. In this nominal operating state, the emergency energy source 6 is deactivated, the inflatable evacuation device 4 is retained in its retracted storage position, remaining fixed to the door 1, and the isolation box 7 enables powering of the ejector 3 and of the retaining bar actuator 5 by the onboard electrical network 8. No element is electrically powered by the emergency energy source 6 in the nominal operating state.

In this nominal operating state, the ejector 3 can be controlled in a mode for assisting opening/closing of the door. The actuation means of the ejector 3 are then driven in movement at low speed corresponding to normal opening or closing of the door. This can be because of control by a user and the control unit 9 can then be provided with a control interface (screen, keys, etc.) enabling the user to actuate powered opening or closing of the door. Alternatively, the door may include sensors detecting manual opening/closing of the door by a user acting on the opening handle 17 and the ejector 3 may be controlled in response to such detection, accompanying the gesture of the user with the ejector in assistance mode.

In this nominal operating state, the retaining bar actuator 5 is controlled by the control unit 9:
to disarm the inflatable evacuation device 4 at the command of a user acting on the arming/disarming handle 18, so that the door can be opened/closed normally;
to arm the inflatable evacuation device 4 at the command of a user acting on the arming/disarming handle 18, or automatically, pending the flight of the aircraft;
to disarm the inflatable evacuation device 4 when the latter is armed and the door 1 is opened from the exterior of the aircraft.

When the inflatable evacuation device 4 is armed and a user actuates opening of the door 1 from the interior of the aircraft by actuating the handle 17, the mechanical trigger 14 associated with the door opening mechanism 13 activates the emergency energy source 6. To be more precise, the mechanical connection means 19 enables direct activation of the mechanical trigger 14 by the physical movement of the handle 17 without necessitating any exterior energy source. This emergency situation arises, for example, if the door is opened in an emergency following an accident, even if all the onboard electrical means are inoperative.

Here the mechanical trigger 14 drives activation of a heating element that triggers the activation of the thermal battery here constituting the emergency energy source 6. The mechanical trigger 14 may be associated with any appropriate heating element, such as friction devices, electric devices, or powder devices.

The control unit 9, which is connected to the emergency energy source 6, therefore receives information relating to the activation of the emergency energy source 6. The control unit 9 then goes to an emergency operating state and causes the isolation box 7 to break the circuit so that the onboard electrical network 8 no longer powers any element 3, 5, 9.

In this emergency operating state, the control module 9 is now powered by the emergency energy source 6 and executes the following commands:
the ejector 3 is commanded in emergency opening mode to bring about very rapid opening of the door;
the means for inflating the inflatable evacuation device 4 are then commanded in emergency inflation mode to bring about very rapid inflation (in a few seconds) of the inflatable evacuation device.

The ejector 3, and likewise the inflatable evacuation device 4, may be controlled in a more sophisticated manner in these emergency modes by the control electronics. For example, the ejector 3 may slow down the opening of the door 1 when the inflatable evacuation device 4 is detached from the door and then accelerate opening again. Different inflation speeds for the inflatable evacuation device 4 may equally be used during this inflation operation.

When the inflatable evacuation device 4 is armed (arming/disarming handle 18 in the armed position) and a user actuates opening from outside, the aircraft by actuating the exterior handle of the door 1, the opening mechanism 13 also activates the mechanical trigger 14 and therefore the emergency energy source 6 by means of the mechanical connection 19. This emergency situation arises, for example, if the door is opened following an accident, but from the outside (for example by rescuers). However, in this situation of opening from the outside, the control unit 9 goes to another operating state referred to here as the “opening from the outside operating state”. In this opening from the outside operating state, the control unit 9 causes the isolation box 7 to break the circuit, so that the onboard electrical network 8 no longer supplies any element 3, 5, 9. The control module 9 is now powered by the emergency energy source 6 and executes the following commands:
disarm the inflatable evacuation device 4;
because the ejector 3 to perform opening in a nominal opening mode, which is to say, in the same manner as during nominal functioning (opening the door at normal speed, not emergency opening).

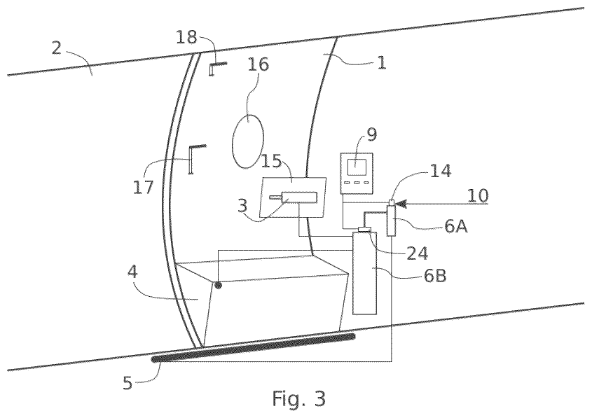

FIG. 3 depicts an embodiment relating to a variant emergency energy source. Elements common to the first embodiment from FIG. 1 bear the same reference numbers in the figures.

In accordance with this embodiment, the emergency energy source includes two thermal batteries 6A, 6B, the first thermal battery 6A being of reduced capacity and volume compared to the second thermal battery 6B.

In FIG. 3, only the details relating to this thermal battery structure have been represented but this variant, nevertheless contains the same elements as the FIG. 1 embodiment. Thus, the first thermal battery 6A includes a mechanical trigger 14 that can be activated (as depicted by the arrow 10) by mechanical connections connected to the interior opening handle 17 and the exterior opening handle.

The first thermal battery 6A is electrically connected to supply electrical energy only to the retaining bar actuator 5 and to a trigger 24 of the second thermal battery 6B. The first thermal battery 6A is therefore rated only to power the retaining bar actuator 5 and the trigger 24 of the second thermal battery 6B, which have a low consumption of electrical energy.

The second thermal battery 6B is connected to serve as an electrical power supply to the ejector 3 and to the inflation means of the inflatable evacuation device 4, which are large consumers of electrical energy, and the second thermal battery 6B, as well as the associated power supply cables, are rated accordingly.

The control unit 9 is connected to the two thermal batteries so as to be aware of their respective state.

In accordance with this configuration, the nominal operating state of the control unit 9 is the same as in the first embodiment. In the emergency operating state, the (interior or exterior) opening handle will trigger the trigger 14 of the first thermal battery 6A mechanically and the latter, being of reduced size, will be activated very rapidly. The electrical power supply of the retaining bar actuator 5 is then available very rapidly and the first thermal battery 6A activates in parallel to the larger second thermal battery 6B, which requires a longer activation time.

In the emergency operating state triggered from the exterior, if a user actuates the exterior opening handle when the door is armed, this architecture guarantees that the retaining bar actuator 5 is electrically powered very rapidly by the first thermal battery 6A, so that the control unit 9 is able to disarm the inflatable safety device 4 rapidly. The first thermal battery 6A can then be placed at a distance from the actuator 5 by power supply cables of small cross-section, given the low electrical consumption of this actuator 5. The location of the first thermal battery 6A can therefore be optimized, so as to be as close as possible to the mechanical triggering elements (the mechanical connection 19 to the opening handles) with few constraints regarding its electrical wiring.

For its part, the second thermal battery 6B is placed as close as possible to its electrical consumers to limit losses and the length of the cables of large cross-section needed, with no constraints relating to its triggering, the latter being obtained by means of a simple electrical cable of small cross-section from the first thermal battery 6A. The second thermal battery 6B is triggered with a delay relative to the first thermal battery 6B, whilst nevertheless allowing timely powering of the elements 3, 4 concerned.

Alternatively, as many thermal batteries as necessary may be used and triggered in cascade in this first design where a first thermal battery of low capacity is triggered first to render rapidly available the powering of an element that needs to be powered as a priority.

### Embodiment Using the Supercapacitor as an Emergency Energy Source

In this embodiment, the supercapacitor replaces the thermal battery described in the previous embodiment. In this embodiment, the operational mode is similar to the operational mode of the previous embodiment. In this embodiment, the supercapacitor keeps the energy only for few days comparing to the thermal battery. Thus it needs to be connected to the A/C power bus in order to guaranty it is always fill up.

The advantage of this embodiment is that the electrical energy is directly available, whereas in the case of a battery, a chemical reaction is required, which introduces latency. In addition, the positioning of the supercapacitor on the door has low impact.

Another advantage of the supercapacitor is that it can be reused after an emergency opening. Reloading will be quick. Thermal battery needs to be replaced after utilization.

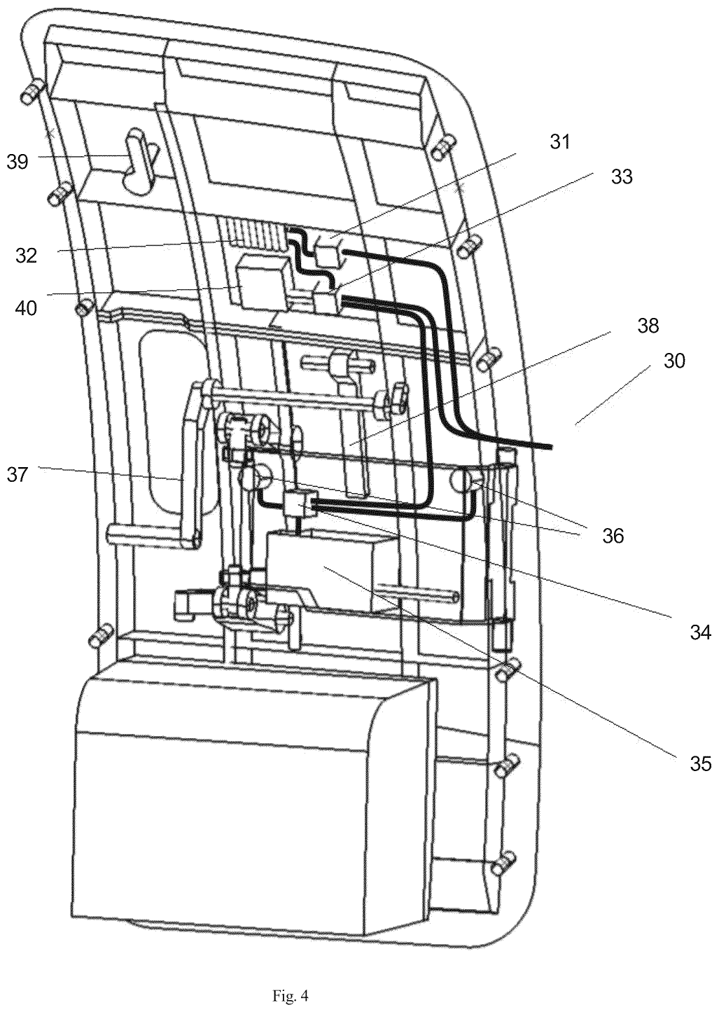

As can be seen in FIG. 4
30 Is the aircraft Power Bus;
31 Is the charger Balancer of supercapacitor. In order to reduce the size of the actuator in emergency mode, the supercapacitor could be charged at a higher tension than the aircraft power bus. This component is not bidirectional. It allows to charge, not the discharge of the supercapacitor in the aircraft network.
32 are the supercapacitor cells. Size and number will be adjusted depending on the type and the energy needed during emergency opening.
33 Is the mechanical selector. It allows to shift from A/C power bus (normal opening) to the supercapacitor power (emergency opening). It is driven mechanically by the logic mechanism (11). It also gives the information of normal or emergency opening to the actuator logic box (5). This selector is initially put in the normal opening position.
34 Is the actuator logic control. It provides power and command to the engine, depending on the door status. In normal operation, it will drive the opening or closing, depending on control switch (not represented) and door captors (7), in a low-speed profile mode. In emergency, it opens the door, depending on the door captors (7) with the emergency speed profile. This speed profile considers low speed at the beginning to facilitate slide deployment. As soon as the slide is dropped, door is accelerated to reach the opening time requirement.
35 Is the door electrical actuator. This element act on the door hinge. It contains two command programs. One for the emergency mode, the other for the normal opening mode. Those programs could be installed in a box separately from the engine.
36 Is the door captor. The control of the engine requires the position of the hinge arm, and the position of the door relatively to the closing means (mechanism position).
37 Is the internal opening handle.
38 Is the external opening handle.
39 Is the arming/disarming handle. This handle allows to put the door in emergency status (armed position)
40 Is the mechanical logic box. This box is mechanically connected to the handle 37, 38, 39.

When the arming/disarming handle is in disarmed position, the opening with internal or external handle, the mechanical logic box does not generate mechanical motion to switch the status of the mechanical selector.

When the arming/disarming handle is in armed position, the opening with internal handle, the mechanical logic box generates a mechanical motion to switch the status of the mechanical selector from normal opening to emergency opening. The power source is changed from the A/C network to the supercapacitor.

When the arming/disarming handle is in armed position, the opening with external handle, the mechanical logic box does not generate mechanical motion to switch the status of the mechanical selector.

The supercapacitor may, for example, may include any number of cells depending on the power needed. In one example, the supercapacitor may include twelve cells. The supercapacitor is connected to a charger that maintains its charge during normal phases when the aircraft is powered by the onboard electrical network, thereby ensuring that energy is available in an emergency when the mechanical trigger is activated when opening in the armed position.

The supercapacitor is connected to the mechanical system. In order to optimize the electric motor, the supercapacitor is charged at a voltage slightly higher, about 32 volts, than that of the onboard electrical network, because the motor is sensitive to voltage variations. This ensures that during emergency opening, the voltage remains within the optimal range and does not drop below the motor's minimum operating value.

This system is generally more compact than a thermal battery. Unlike in the configuration described in the previous embodiment, the supercapacitor will not power the inflatable evacuation device. It will only power the retaining bar actuator (if this actuator is electric).

Two actuator modes are provided:
a nominal operating state, in which a moderate angular velocity of the door is sought and manual control is possible, so that the operator can stop the door if an obstacle is encountered; and
an emergency operating state, in which the actuator speed profile is optimized to reduce the risk of the inflatable evacuation device not deploying correctly.

In the emergency operating state, the actuator speed is initially reduced during the phase in which the deployment of the inflatable evacuation device may be at risk (for example, risk of non-deployment or poor deployment). Once the inflatable evacuation device is deployed, the speed is then increased to ensure an acceptable door opening time.

In this architecture, a single common energy source powers both the triggering functions (signal logic) and the actuation functions (motion energy source). For the supercapacitor alternative, unlike the dual thermal battery configuration of the previous embodiment, the supercapacitor does not power the inflatable evacuation device, but only the retaining bar actuator.

Variants of the aircraft door architecture may be employed. For example, the control electronics of the control unit 9 may be physically grouped with the power elements of the isolation box 7 in the same casing, which may also optionally contain the control electronics of the various actuators.

Arming and disarming of the door in the nominal operating mode can also be commanded by the control unit 9, in addition to or instead of a mechanical arming/disarming handle. The user is then able to arm and disarm the door directly at the user interface of the control unit 9, which actuates the retaining bar actuator 5 electrically. In this case, the coupling means 20 is an electromechanical component activated by the control unit when the user arms the door.

The electrical architecture may be modified whilst retaining the same functionalities, for example, electrically powering the actuators, either by the onboard network or by the emergency energy source, may be directly controlled by the control unit 9.

The emergency energy source may moreover consist of energy sources other than electrical energy sources. For example, the emergency energy source may be a source of pneumatic energy. This energy is then distributed by pneumatic distributors and regulators feeding pneumatic actuators.

1. An aircraft door architecture comprising:
a door adapted to be mounted in an opening in a fuselage of an aircraft and adapted to occupy an open position and a closed position;
an ejector adapted to drive emergency opening of the door;
an inflatable evacuation device adapted to occupy a retracted storage position and a deployed evacuation position;
a retaining bar actuator that can be activated between: an arming position in which the inflatable evacuation device is retained; and a disarming position in which the inflatable evacuation device is released;
a supercapacitor as an emergency energy source connected to the retaining bar actuator, the emergency energy source being adapted to activate an actuating device for actuating the ejector, an inflating device for inflating the inflatable evacuation device, and the retaining bar actuator;
a control unit having the following two operating states: a nominal operating state in which the inflatable evacuation device is retained in the retracted position and the emergency energy source is deactivated; and an emergency operating state in which the emergency energy source activates the actuating device in an emergency mode of opening the door and activates the inflating device in an emergency inflation mode;
wherein the emergency energy source is an electric secondary cell;
the ejector includes an electric actuation device; the inflatable evacuation device includes an electric inflation device;
wherein the emergency energy source includes a supercapacitor; and
wherein the supercapacitor powers the retaining bar actuator and powers the ejector and the inflating device.

2. The aircraft door architecture as claimed in claim 1, wherein the control unit includes a control interface for a user, the control interface being adapted to drive the retaining bar actuator to the arming position or the disarming position when the control unit is in the nominal operating state.

3. The aircraft door architecture as claimed in claim 1, wherein the control unit further includes an opening from the exterior operating state in which the control unit drives the retaining bar actuator to the disarming position in the event of opening of the door from the exterior.

4. The aircraft door architecture as claimed in claim 3, wherein in the opening from the exterior operating mode, the control unit activates the actuating device in a nominal mode of opening the door.

5. The aircraft door architecture as claimed in claim 1, wherein in the nominal operating state, the control unit is adapted to control the ejector n accordance with a mode for assisting opening/closing of the doo.

6. The aircraft door architecture as claimed in claim 5, wherein the control interface for a user is adapted also to control the ejector in the mode for assisting opening/closing of the door.

7. The aircraft door architecture as claimed in claim 1, wherein the emergency energy source is activated by a mechanical trigger connected to a mechanism for opening/closing the door.

8. The aircraft door architecture as claimed in claim 7, wherein the door comprises an arming/disarming handle, and in that, the mechanism for opening/closing the door comprises an opening handle that is mechanically connected to the mechanical trigger by a coupling device actuated by the arming/disarming handle.

9. The aircraft door architecture as claimed in claim 1, wherein the ejector includes connectors for electrical connection to an onboard electrical network of an aircraft, the electric actuation device also being adapted to be activated by an aircraft onboard electrical network.

10. The aircraft door architecture as claimed in claim 9, further including an isolation box having a mode enabling electrical connection of the ejector and a mode for breaking that electrical connection.

11. The aircraft door architecture as claimed in claim 10, wherein the isolation box is activated in breaking mode upon activation of the emergency energy source.

12. The aircraft door architecture as claimed in claim 11, wherein the retaining bar actuator includes connectors for electrical connection to an onboard electrical network of an aircraft, the retaining bar actuator also being adapted to be activated by an aircraft onboard electrical network.
